(19) United States
(12) Patent Application Publication
(10) Pub. No.: US 2026/0111979 A1
(43) Pub. Date: Apr. 23, 2026

(54) NEGOTIATION DEVICE, NEGOTIATION METHOD, AND RECORDING MEDIUM

(71) Applicant: NEC Corporation, Minato-ku, Tokyo (JP)

(72) Inventors: Tomohito ANDO, Tokyo (JP); Satoshi MORINAGA, Tokyo (JP); Shinji NAKADAI, Tokyo (JP)

(73) Assignee: NEC Corporation, Minato-ku, Tokyo (JP)

(21) Appl. No.: 19/118,049

(22) PCT Filed: Oct. 13, 2022
(86) PCT No.: PCT/JP2022/038196

§ 371 Date: Apr. 3, 2025

(51) Int. Cl. G06Q 50/18

(52) U.S. Cl. CPC G06Q 50/188

(57) ABSTRACT

In order to solve the problem of increasing the possibility of reaching the formation of agreement on the basis of an agreement candidate proposal provided in a negotiation, a negotiation apparatus (1) includes: a provision reason adding section (11) for adding, in a first negotiation with a first negotiation party, a reason for provision to an agreement candidate proposal which is to be provided to the first negotiation party; and an agreement candidate proposal providing section (12) for providing the first negotiation party with the agreement candidate proposal which has the reason for provision added thereto.

### TECHNICAL FIELD

The present invention relates to a technique for conducting a negotiation.

### BACKGROUND ART

Patent Literature 1 discloses a negotiation system which includes an order-accepting-side negotiation system and an order-placing-side negotiation system. The order-accepting-side negotiation system stores negotiation candidates corresponding to an order from the order-placing-side negotiation system such that the negotiation candidates are each associated with utility. Further, the order-accepting-side negotiation system transmits, to the order-placing-side negotiation system, a negotiation candidate with greater utility first, from among the stored negotiation candidates.

### CITATION LIST

### Patent Literature

[Patent Literature 1]

Pamphlet of International Publication No. WO 2021/038626

### SUMMARY OF INVENTION

### Technical Problem

In the system disclosed in Patent Literature 1, although a negotiation candidate (provided agreement candidate proposal) transmitted by the order-accepting-side negotiation system is of great utility to the order-accepting-side negotiation system, it is unclear whether the negotiation candidate is of great utility to the order-placing-side negotiation system. The system is therefore susceptible of an increase in the possibility of reaching the formation of agreement on the basis of the provided agreement candidate proposal. An example aspect of the present invention has been made in view of the above problem, and example object thereof is to provide a technique for increasing the possibility of reaching the formation of agreement on the basis of an agreement candidate proposal provided in a negotiation.

### Solution to Problem

A negotiation apparatus in accordance with an example aspect of the present invention includes: a provision reason adding means for adding, in a first negotiation with a first negotiation party, a reason for provision to an agreement candidate proposal which is to be provided to the first negotiation party; and an agreement candidate proposal providing means for providing the first negotiation party with the agreement candidate proposal which has the reason for provision added thereto.

A negotiation method in accordance with an example aspect of the present invention includes: a computer adding, in a first negotiation with a first negotiation party, a reason for provision to an agreement candidate proposal which is to be provided to the first negotiation party; and the computer providing the first negotiation party with the agreement candidate proposal which has the reason for provision added thereto.

A program in accordance with an example aspect of the present invention causes a computer to function as: a provision reason adding means for adding, in a first negotiation with a first negotiation party, a reason for provision to an agreement candidate proposal which is to be provided to the first negotiation party; and an agreement candidate proposal providing means for providing the first negotiation party with the agreement candidate proposal which has the reason for provision added thereto.

### Advantageous Effects of Invention

With an example aspect of the present invention, it is possible to increase the possibility of reaching the formation of agreement on the basis of an agreement candidate proposal provided in a negotiation.

### BRIEF DESCRIPTION OF DRAWINGS

FIG. 1 is a block diagram illustrating a configuration of a negotiation apparatus in accordance with a first example embodiment.

FIG. 2 is a flowchart illustrating a flow of a negotiation method in accordance with the first example embodiment.

FIG. 3 is a block diagram illustrating a configuration of a negotiation system in accordance with a second example embodiment.

FIG. 4 is a block diagram illustrating an example functional configuration of the negotiation apparatus illustrated in FIG. 3.

FIG. 5 is a block diagram illustrating an example functional configuration of another negotiation apparatus illustrated in FIG. 3.

FIG. 6 is a flowchart illustrating a flow of an information processing method in accordance with the second example embodiment.

FIG. 7 is a diagram illustrating an example transition of screens and processes in a specific example of the information processing method illustrated in FIG. 6.

FIG. 8 is a diagram illustrating a detailed example of a screen illustrated in FIG. 7.

FIG. 9 is a diagram illustrating a detailed example of another screen illustrated in FIG. 7.

FIG. 10 is a diagram illustrating a detailed example of still another screen illustrated in FIG. 7.

FIG. 11 is a diagram illustrating a detailed example of still another screen illustrated in FIG. 7.

FIG. 12 is a diagram illustrating a detailed example of still another screen illustrated in FIG. 7.

FIG. 13 is a diagram illustrating a detailed example of still another screen illustrated in FIG. 7.

FIG. 14 is a diagram illustrating a detailed example of yet still another screen illustrated in FIG. 7.

FIG. 15 is a flowchart illustrating a flow of another information processing method in accordance with the second example embodiment.

FIG. 16 is a diagram illustrating a detailed example of a screen in the specific example of the information processing method illustrated in FIG. 15.

FIG. 17 is a diagram illustrating a detailed example of another screen in a specific example of the information processing method illustrated in FIG. 15.

FIG. 18 is a block diagram illustrating a configuration of a negotiation system in accordance with a variation of the second example embodiment.

FIG. 19 is a diagram illustrating an example hardware configuration of an apparatus in accordance with the example embodiments.

### EXAMPLE EMBODIMENTS

In the following description, a “negotiation party” refers to, for example, a party which has the ability to generate an agreement candidate proposal to be provided to another negotiation party and the ability to determine whether to agree to an agreement candidate proposal acquired from another negotiation party. The negotiation party may be an apparatus, may be a human being, or may be an organization. A “negotiation apparatus” refers to, for example, an apparatus which functions as the negotiation party. The “negotiation apparatus” can also refer to, for example, an apparatus which functions on the basis of operations performed by a human being who is the negotiation party or a human being who belongs to an organization that is the negotiation party. Examples of the negotiation apparatus include a computer, a robot, a drone, and a self-driving vehicle. Further, a “negotiation” refers to, for example, provisions of an agreement candidate proposal which alternate between negotiation parties until the formation of agreement is achieved between the negotiation parties. The negotiation may be a negotiation between parties the interests of which conflict, or may be a negotiation (adjustment) between parties the interests of which do not conflict.

Note that the following description is presented under the assumption that a bilateral negotiation is conducted by two negotiation parties which share a set of agreement candidate proposals. However, this assumption is for convenience of description, and a multilateral negotiation conducted by three or more negotiation parties is within the scope of the present invention.

### First Example Embodiment

A first example embodiment of the present invention is described here in detail with reference to the drawings. The present example embodiment is basic to example embodiments which will be described later.

### Configuration of Negotiation Apparatus 1

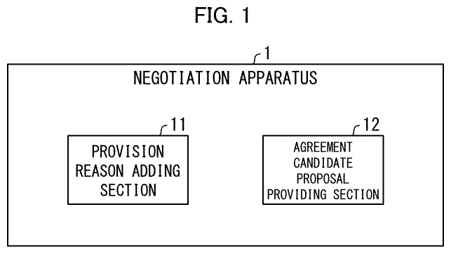

The configuration of a negotiation apparatus 1 in accordance with the present example embodiment is described here with reference to FIG. 1. FIG. 1 is a block diagram illustrating the configuration of the negotiation apparatus 1. The negotiation apparatus 1 includes a provision reason adding section 11 and an agreement candidate proposal providing section 12, as illustrated in FIG. 1. The provision reason adding section 11 adds, in a first negotiation with a first negotiation party, a reason for provision to an agreement candidate proposal which is to be provided to the first negotiation party. The agreement candidate proposal providing section 12 provides the first negotiation party with the agreement candidate proposal which has the reason for provision added thereto.

### Implementation Via Program

The functions of the negotiation apparatus 1 above can be implemented via a program. A program in accordance with the present example embodiment causes a computer to function as: the provision reason adding section 11 for adding, in a first negotiation with a first negotiation party, a reason for provision to an agreement candidate proposal which is to be provided to the first negotiation party; and the agreement candidate proposal providing section 12 for providing the first negotiation party with the agreement candidate proposal which has the reason for provision added thereto.

### Flow of Negotiation Method S1

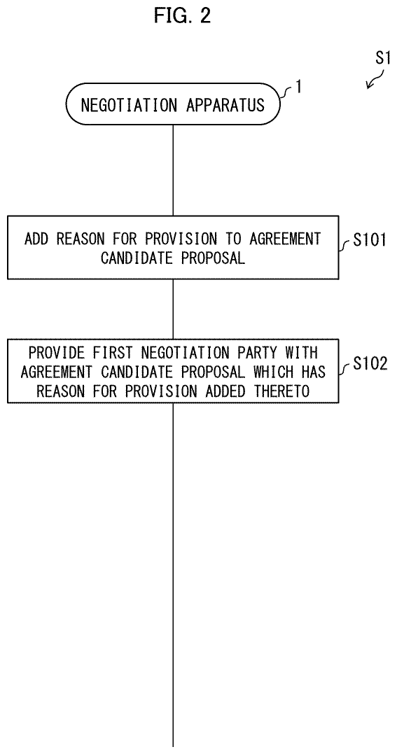

The flow of a negotiation method S1 in accordance with the present example embodiment is described here with reference to FIG. 2. FIG. 2 is a flowchart illustrating the flow of the negotiation method S1. The negotiation method S1 includes steps S101 and S102, as illustrated in FIG. 2. In step S101, a computer adds, in a first negotiation with a first negotiation party, a reason for provision to an agreement candidate proposal which is to be provided to the first negotiation party. In step S102, the computer provides the first negotiation party with the agreement candidate proposal which has the reason for provision added thereto.

### Example Advantage of Present Example Embodiment

As above, a configuration adopted in the negotiation apparatus 1, the program, and the negotiation method S1 in accordance with the present example embodiment is such that a reason for provision is added, in a first negotiation with a first negotiation party, to an agreement candidate proposal to be provided to the first negotiation party, and the agreement candidate proposal which has the reason for provision added thereto is provided to the first negotiation party. Thus, the present example embodiment provides an example advantage of making it possible to increase the possibility of obtaining an agreement to an agreement candidate proposal provided in a negotiation.

### Second Example Embodiment

A second example embodiment of the present invention is described here in detail with reference to the drawings. Note that a component having the same function as a component described in the first example embodiment is assigned the same reference sign, and the description thereof is omitted where appropriate.

In the present example embodiment, the reason for provision added, in a first negotiation with a first negotiation party, to an agreement candidate proposal which is to be provided to the first negotiation party is based on the status of a second negotiation, which is different from the first negotiation party. Further, the second negotiation is a negotiation with a second negotiation party conducted in association with the first negotiation, the second negotiation party being different from the first negotiation party.

### Configuration of Negotiation System 100

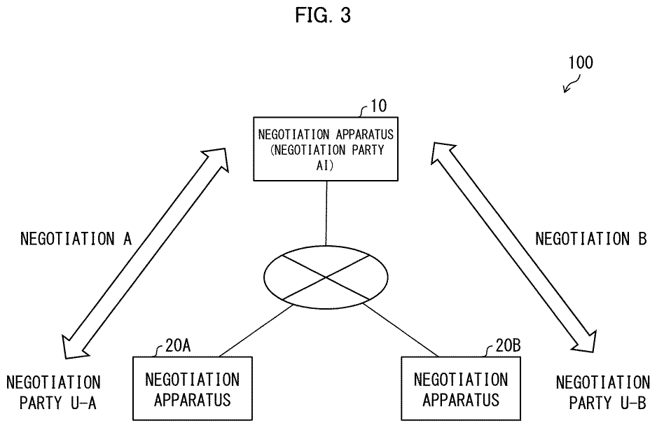

FIG. 3 is a block diagram illustrating the configuration of a negotiation system 100 in accordance with the present example embodiment. The negotiation system 100 includes a negotiation apparatus 10, a negotiation apparatus 20A, and a negotiation apparatus 20B, as illustrated in FIG. 3. The negotiation apparatus 10, the negotiation apparatus 20A, and the negotiation apparatus 20B are communicably connected together over a network.

The negotiation apparatus 10 functions as a negotiation party AI which conducts a negotiation with another negotiation party without relying on a user operation. The negotiation apparatus 20A is used by a negotiation party U-A, which is a human being or an organization, in order to conduct a negotiation with another negotiation party. The negotiation apparatus 20A has the function of conducting a negotiation with another negotiation party on the basis of operations of a human being who is the negotiation party U-A (or operations of a human being who belongs to an organization which is the negotiation party U-A). The negotiation apparatus 20B is used by a negotiation party U-B, which is a human being or an organization, in order to conduct a negotiation with another negotiation party. The negotiation apparatus 20B has the function of conducting a negotiation with another negotiation party on the basis of operations of a human being who is the negotiation party U-B (or operations of a human being who belongs to an organization which is the negotiation party U-B). Further, a negotiation A is conducted between the negotiation apparatus 10 and the negotiation party U-A, and a negotiation B is conducted between the negotiation apparatus 10 and the negotiation party U-B.

Each of the negotiation apparatuses 10, 20A, and 20B is an example of the negotiation apparatus recited in the claims. For example, in a case where the negotiation apparatus 10 (negotiation party AI) is applied as an example of the negotiation apparatus recited in the claims, the negotiation party U-A can be applied as an example of the first negotiation party, and the negotiation party U-B can be applied as an example of the second negotiation party. Alternatively, the negotiation party U-A can be applied as an example of the second negotiation party, and the negotiation party U-B can be applied as an example of the first negotiation party. Further, in a case where the negotiation apparatus 20A or the negotiation apparatus 20B is applied as an example of the negotiation apparatus recited in the claims, the negotiation apparatus 10 (negotiation party AI) can be applied as an example of the first negotiation party.

### Specific Examples of Negotiation and Negotiation Party

Description of the present example embodiment will center on an example in which a negotiation on placement and acceptance of an order for a product is applied as the negotiation A and the negotiation B. In this example, a client A, which purchases a product, is applied as the negotiation party U-A, and a supplier B of the product is applied as the negotiation party U-B. Further, the negotiation apparatus 10, which is the negotiation party AI, functions as an agent for a middleman M. For example, the negotiation A is conducted in order for the agent (negotiation party AI) for the middleman M to accept an order from the client A (negotiation party U-A) for a product. The negotiation B is conducted in association with the negotiation A, and is conducted in order to place an order with the supplier B (negotiation party U-B) for the product (or a part of the product) ordered by the client A.

### Configuration of Negotiation Apparatus 10

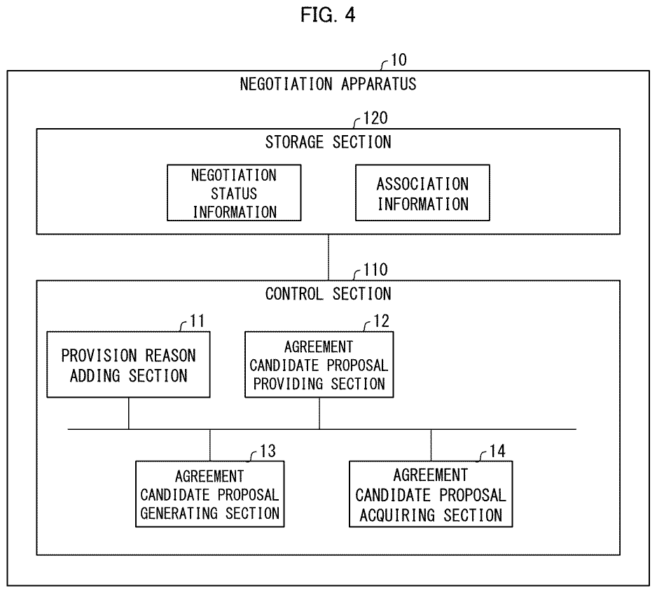

FIG. 4 is a block diagram illustrating an example functional configuration of the negotiation apparatus 10. The negotiation apparatus 10 includes a control section 110 and a storage section 120, as illustrated in FIG. 4. The control section 110 performs overall control of the sections of the negotiation apparatus 10. The control section 110 includes a provision reason adding section 11, an agreement candidate proposal providing section 12, an agreement candidate proposal generating section 13, and an agreement candidate proposal acquiring section 14. The storage section 120 stores various kinds of data used by the control section 110. The storage section 120 stores negotiation status information and association information.

The agreement candidate proposal generating section 13 generates an agreement candidate proposal to be provided to the negotiation party U-A. The provision reason adding section 11 refers to association information which indicates an association between the negotiation A and the negotiation B and negotiation status information which indicates the status of the negotiation B to generate a reason for provision, and adds the generated reason for provision to the agreement candidate proposal to be provided to the negotiation party U-A. Further, the provision reason adding section 11 refers to information which indicates the content of an agreement candidate proposal in the negotiation B or the result of the negotiation B, as the negotiation status information which indicates the status of the negotiation B.

The provision reason adding section 11 further adds, to the agreement candidate proposal, guarantee information for guaranteeing the validity of the reason for provision. The guarantee information is for guaranteeing that the reason for provision is generated by a computer on the basis of the association information and the negotiation status information.

The agreement candidate proposal providing section 12 provides the negotiation party U-A with the agreement candidate proposal which has added thereto the reason for provision and the guarantee information. Specifically, the agreement candidate proposal providing section 12 provides the negotiation party U-A with the agreement candidate proposal by transmitting this agreement candidate proposal to the negotiation apparatus 20A. Hereinafter, “providing the negotiation party U-A with the agreement candidate proposal” can be expressed as “transmitting the agreement candidate proposal to the negotiation apparatus 20A”.

The agreement candidate proposal acquiring section 14 acquires the agreement candidate proposal provided by the negotiation party U-A. Specifically, the agreement candidate proposal providing section 12 acquires this agreement candidate proposal by receiving the agreement candidate proposal from the negotiation apparatus 20A. Hereinafter, “acquiring the agreement candidate proposal provided by the negotiation party U-A” can be expressed simply as “receiving the agreement candidate proposal from the negotiation apparatus 20A”.

It should be noted that the above-described configurations of the provision reason adding section 11, the agreement candidate proposal providing section 12, the agreement candidate proposal generating section 13, and the agreement candidate proposal acquiring section 14 are each described similarly even in a case of interchanging A and B.

### Negotiation Status Information

The negotiation status information indicates the status of a negotiation. For example, the negotiation status information is associated with identification information for identifying the negotiation A and the negotiation B. The negotiation status information associated with the identification information for the negotiation A (or the negotiation B) can also be expressed as negotiation status information for the negotiation A (or the negotiation B). The negotiation status information may include a history of agreement candidate proposals shared in the negotiation. The negotiation status information may further include the result of a negotiation in a case where the negotiation has already ended. The result of a negotiation indicates, for example, a final agreement, a final disagreement, or a cancellation of the negotiation itself.

### Association Information

The association information indicates an association between the negotiation A and the negotiation B. In the present example embodiment, an example in which the association information indicates a nested negotiation is described. That is, the negotiation A and the negotiation B are nested negotiations.

### Nested Negotiation

The nested negotiation is an example association of conducting one of the negotiation A and the negotiation B for the formation of agreement in the other. For example, in order to accept an order in the negotiation A with a delivery plan Al (including a delivery date and a quantity) desired by the client A, the negotiation B is conducted to have the supplier B make a delivery with a delivery plan B1, which meets the delivery plan A1. Further, assume that in such a negotiation B, the supplier B cannot meet the delivery plan B1. In this case, in order to approve, in the negotiation B, of a delivery plan B2, which is possible for the supplier B to meet, the negotiation A continues to be conducted to have the client A approve of a delivery plan A2, according to which it is possible to make the delivery to the client in response to the delivery plan B2.

### Configuration of Negotiation Apparatus 20A

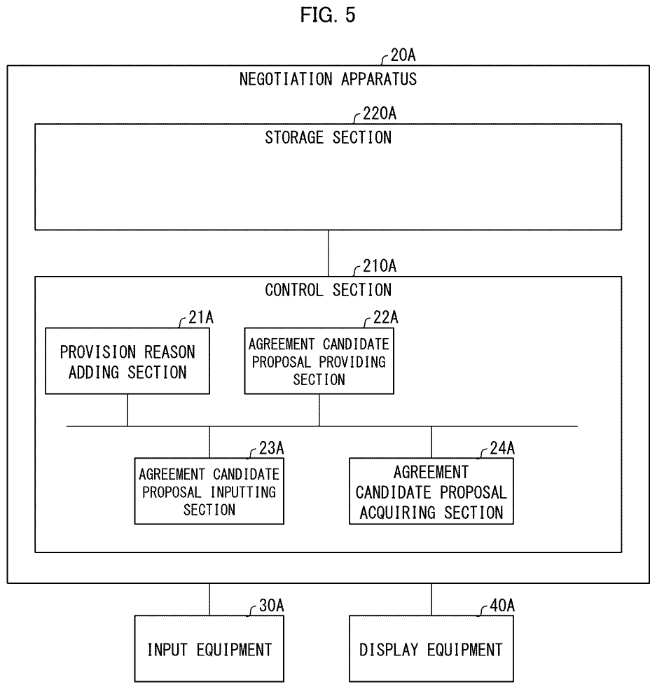

FIG. 5 is a block diagram illustrating an example functional configuration of the negotiation apparatus 20A. The negotiation apparatus 20A includes a control section 210A and a storage section 220A, as illustrated in FIG. 5. Further, the negotiation apparatus 20A is connected to input equipment 30A and display equipment 40A. The control section 210A performs overall control of the sections of the negotiation apparatus 20A. The control section 210A includes a provision reason adding section 21A, an agreement candidate proposal providing section 22A, an agreement candidate proposal inputting section 23A, and an agreement candidate proposal acquiring section 24A. The storage section 220A stores various kinds of data used by the control section 210A.

The agreement candidate proposal inputting section 23A generates an agreement candidate proposal on the basis of information which is inputted via the input equipment 30A. The provision reason adding section 21A adds, to the agreement candidate proposal, a reason for provision which is inputted via the input equipment 30A.

The agreement candidate proposal providing section 22A provides the negotiation party AI (negotiation apparatus 10) with the agreement candidate proposal which has the reason for provision added thereto. Specifically, the agreement candidate proposal providing section 22A provides the negotiation party AI with the agreement candidate proposal by transmitting the agreement candidate proposal to the negotiation apparatus 10. Hereinafter, “providing the negotiation party AI with the agreement candidate proposal” can be expressed as “transmitting the agreement candidate proposal to the negotiation apparatus 10”.

The agreement candidate proposal acquiring section 24A acquires an agreement candidate proposal which has a reason for provision added thereto and which is provided by the negotiation party AI (negotiation apparatus 10). Specifically, the agreement candidate proposal providing section 12 acquires the agreement candidate proposal from the negotiation party AI by receiving this agreement candidate proposal from the negotiation apparatus 10. Hereinafter, “acquiring the agreement candidate proposal provided by the negotiation party AI” can be expressed as “receiving the agreement candidate proposal from the negotiation apparatus 10”.

### Configuration of Negotiation Apparatus 20B

The configuration of the negotiation apparatus 20B is described similarly by interchanging A with B in FIG. 5 and in the description of the negotiation apparatus 20A made with reference to FIG. 5.

### Flow of Negotiation Method S2

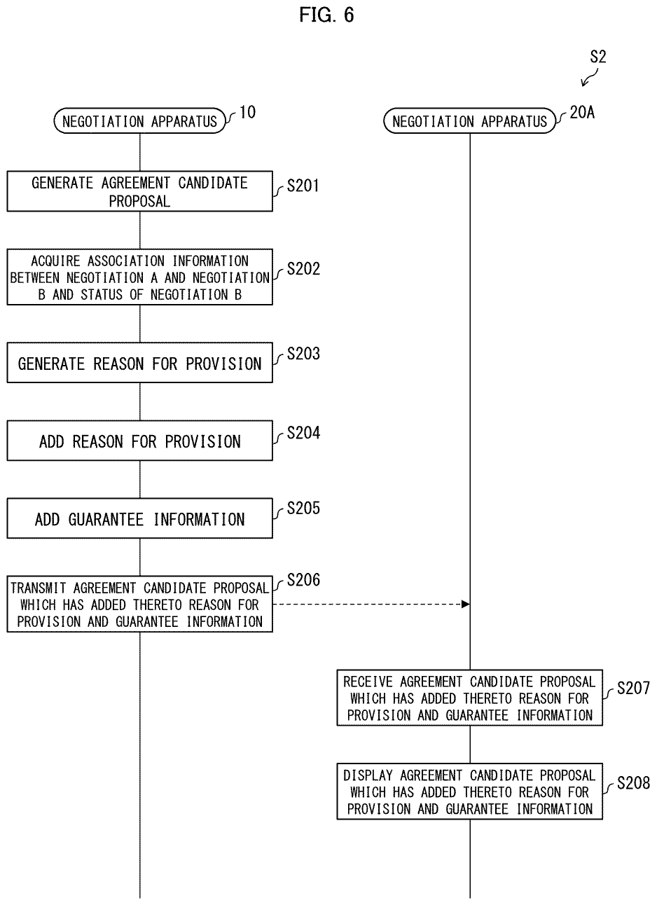

The negotiation system 100 configured as described above carries out a negotiation method S2 in accordance with the present example embodiment. FIG. 6 is a flowchart illustrating the flow of the negotiation method S2. The negotiation method S2 includes a method carried out by the negotiation apparatus 10 as an example of the negotiation apparatus recited in the claims. Note that illustrated in FIG. 6 is the case where the negotiation A, the negotiation party U-A, the negotiation apparatus 20A are examples of the first negotiation, the first negotiation party, the apparatus used by the first negotiation party, respectively, and the negotiation B, the negotiation party U-B, and the negotiation apparatus 20B are examples of the second negotiation, the second negotiation party, and the apparatus used by the second negotiation party, respectively. The negotiation method S2 includes steps S201 to S207, as illustrated in FIG. 6.

In step S201, the agreement candidate proposal generating section 13 of the negotiation apparatus 10 generates an agreement candidate proposal to be provided to the negotiation party U-A. The agreement candidate proposal includes, for example, a delivery plan (including a delivery date and a quantity) of a product which is planned for the negotiation party U-A.

In step S202, the provision reason adding section 11 acquires association information stored in the storage section 120 and negotiation status information for the negotiation B. In step S203, the provision reason adding section 11 refers to the association information and the negotiation status information for the negotiation B to generate a reason for provision. For example, the provision reason adding section 11 may refer to the content of an agreement candidate proposal in the negotiation B or information which indicates the result of the negotiation B, as the negotiation status information for the negotiation B. Further, the provision reason adding section 11 may refer to, for example, information which indicates a nested negotiation, as the association information.

In step S204, the provision reason adding section 11 adds the reason for provision to the agreement candidate proposal. In step S205, the provision reason adding section 11 adds, to the agreement candidate proposal, guarantee information for guaranteeing the validity of the reason for provision. In step S206, the agreement candidate proposal providing section 12 transmits, to the negotiation apparatus 20A, the agreement candidate proposal which has added thereto the reason for provision and the guarantee information.

In step S207, the agreement candidate proposal acquiring section 24A of the negotiation apparatus 20A receives, from the negotiation apparatus 10, the agreement candidate proposal which has added thereto the reason for provision and the guarantee information. In step S208, the agreement candidate proposal acquiring section 24A displays, on the display equipment 40A, the agreement candidate proposal which has added thereto the reason for provision and the guarantee information.

Note that the negotiation method S2 described above and in FIG. 6 is described similarly even in a case of interchanging A and B. In a case of such an interchange, the negotiation A, the negotiation party U-A, and the negotiation apparatus 20A are examples of the second negotiation, the second negotiation party, and the apparatus used by the second negotiation party, respectively. In addition, the negotiation B, the negotiation party U-B, and the negotiation apparatus 20B are examples of the first negotiation, the first negotiation party, and the apparatus used by the first negotiation party, respectively.

### Specific Example of Negotiation Method S2

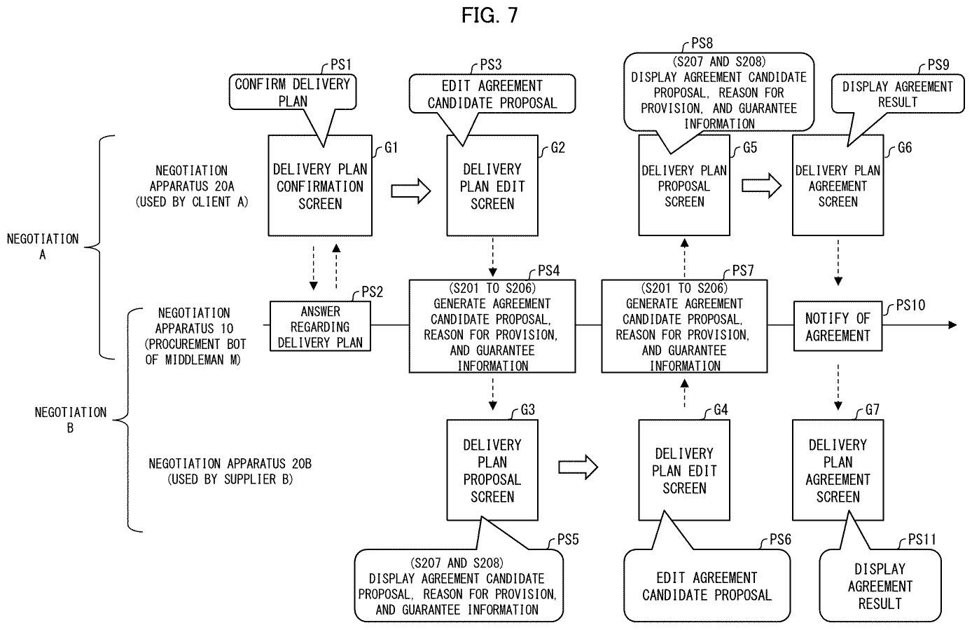

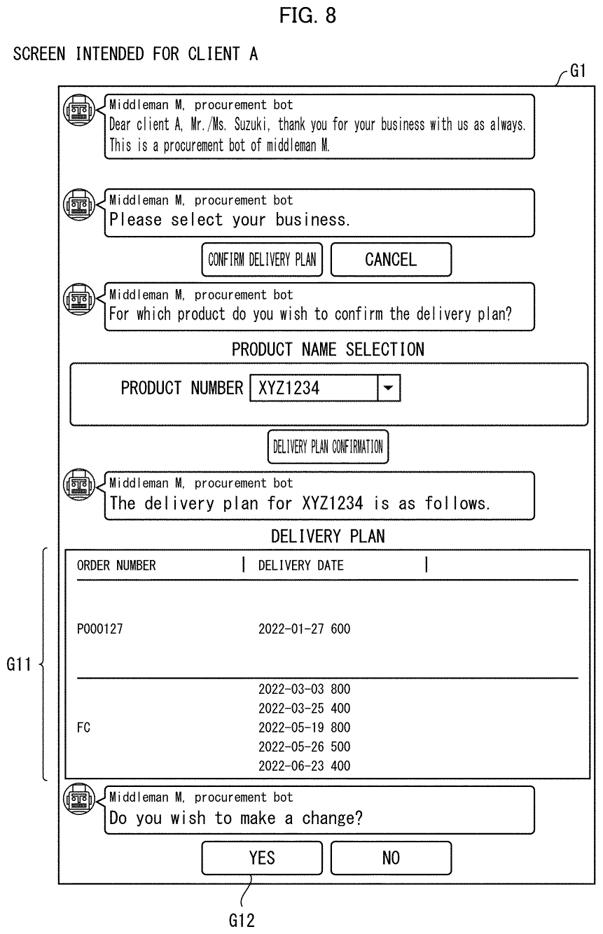

Next, a specific example of the negotiation A and the negotiation B that are conducted with use of the negotiation method S2 is described here with reference to FIGS. 7 to 14. FIG. 7 is a diagram illustrating a specific example of a transition of screens and processes in the negotiation A and the negotiation B. FIGS. 8 to 14 are diagrams illustrating detailed examples of the respective screens illustrated in FIG. 7. Note that the transition and screens are presented by way of example, and in no way limit the present example embodiment.

The status in the specific example is such that the client A places an order for a product with the middleman M, and a delivery has not yet been made. In addition, the status is such that an order for the product to be delivered to the client A is placed by the middleman M with the supplier B, and a delivery has not yet been made. The negotiation apparatus 10 functions as a procurement bot of the middleman M. In the storage section 120, order information on an order placed by the client A with the middleman M and order information on an order placed by the middleman M with the supplier B are stored. The order information includes a current delivery plan. Further, the client A wishes to change a delivery plan, and the negotiation A for changing the delivery plan is conducted between the client A and the negotiation apparatus 10. Further, in response to the negotiation A, the negotiation B for changing a delivery plan is conducted between the negotiation apparatus 10 and the supplier B.

In FIG. 7, the upper row indicates the transition of screens displayed in the negotiation A by the negotiation apparatus 20A, which is used by the client A. Hereinafter, these screens are also expressed as screens intended for the client A. The middle row indicates the transition of processes carried out by the negotiation apparatus 10, which is the procurement bot of the middleman M. The lower row indicates the transition of screens displayed in the negotiation B by the negotiation apparatus 20B, which is used by the supplier B. Hereinafter, these screens are also expressed as screens intended for the supplier B. The specific example includes steps PS1 to PS11. Further, the specific example includes screens G1 to G7.

As illustrated in FIG. 7, the screen G1 intended for the client A indicates a delivery plan confirmation screen. The screen G1 is displayed by carrying out steps PS1 and PS2. In step PS1, on the basis of an operation performed by the client A, the control section 210A of the negotiation apparatus 20A transmits a request for confirmation of a delivery plan for a product the order of which has been placed with the negotiation apparatus 10. In step PS2, the control section 110 of the negotiation apparatus 10 refers to order information in the storage section 120 to acquire the delivery plan for the product, and transmits the delivery plan to the negotiation apparatus 20A.

FIG. 8 is a diagram illustrating a detailed example of the screen G1. The screen G1 includes a delivery plan G11, as illustrated in FIG. 8. The delivery plans on an order “P000127” and an order “FC” for a product “XYZ1234” before the start of the negotiation A are included in the delivery plan G11. The order “P000127” indicates the order which has already assigned an order number “P000127”, and the order “FC” indicates the order which has not yet been assigned an order number. Further, in the order “FC”, the delivery is intended to be made in installments and a plurality of delivery dates are included. Upon an operation performed by the client A on an operation object G12 (“yes” button) in response to the question “Do you wish to make a change?” in the screen G1, the screen G1 transitions to the screen G2.

Next, a return to the description of FIG. 7 is made. As illustrated in FIG. 7, the screen G2 intended for the client A indicates a delivery plan edit screen. On this screen G2, step PS3 is carried out. In step PS3, the agreement candidate proposal inputting section 23A of the negotiation apparatus 20A accepts an operation of editing a pre-change delivery plan, and transmits, to the negotiation apparatus 10, an agreement candidate proposal which includes the delivery plan that has changes made thereto.

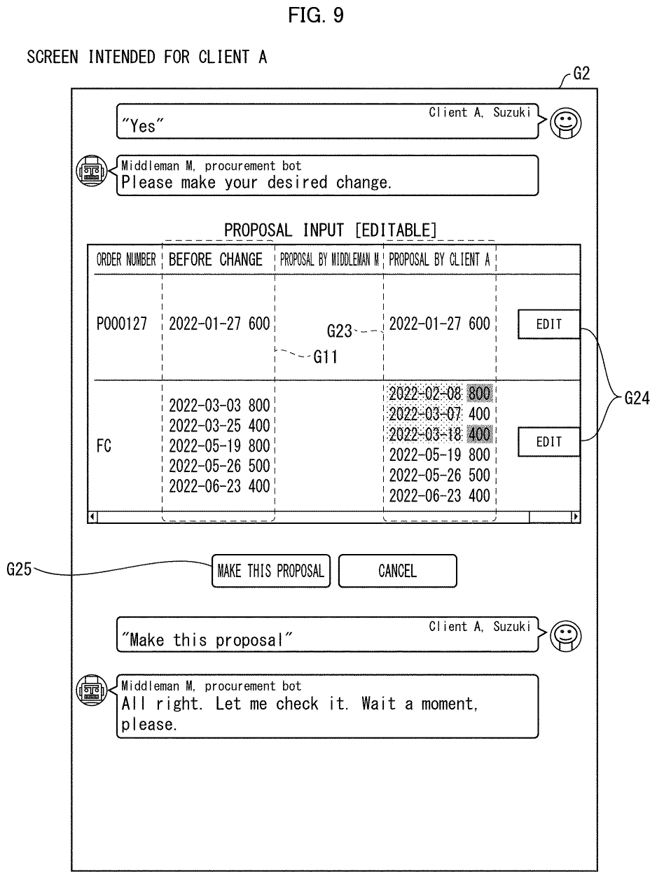

FIG. 9 is a diagram illustrating a detailed example of the screen G2. As illustrated in FIG. 9, the screen G2 includes the pre-change delivery plan G11 and a client's proposal G23 which indicates a delivery plan change suggested by the client A. The client's proposal G23 includes the pre-change delivery plan G11 in a pre-edit state, and becomes editable upon an operation performed on an operation object G24 (“edit” button). In this example, shaded portions in the client's proposal G23 are changes from the pre-change delivery plan G11. In the screen G2, upon an operation performed on an operation object G25 (“make this proposal” button), the agreement candidate proposal providing section 22A of the negotiation apparatus 20A transmits, to the negotiation apparatus 10, an agreement candidate proposal which includes the client's proposal G23.

Next, a return to the description of FIG. 7 is made. As illustrated in FIG. 7, upon reception of the agreement candidate proposal which includes the client's proposal G23, the negotiation apparatus 10 carries out step PS4. Step PS4 includes steps S201 to S206 of the negotiation method S2. That is, the agreement candidate proposal generating section 13 of the negotiation apparatus 10 generates an agreement candidate proposal for sounding the supplier B out about a change in the delivery plan so as to meet the client's proposal G23 which has changes made thereto.

The provision reason adding section 11 of the negotiation apparatus 10 generates a reason for provision with respect to this agreement candidate proposal, and adds the guarantee information. Here, association information which indicates that the negotiation A and the negotiation B are nested negotiations and the negotiation status information (the status where the agreement candidate proposal includes the client's proposal G23 which has changes made thereto) for the negotiation A are referred to, and the reason for provision “because of a sudden request from a client” is generated. Further, the agreement candidate proposal providing section 12 of the negotiation apparatus 10 transmits, to negotiation apparatus 20B, the agreement candidate proposal which has added thereto the reason for provision and the guarantee information.

Next, the negotiation apparatus 20B carries out step PS5. Step PS5 includes steps S207 and S208 of the negotiation method S2. That is, the agreement candidate proposal acquiring section 24B of the negotiation apparatus 20B displays the agreement candidate proposal which has added thereto the reason for provision and the guarantee information. This causes the screen G3 intended for the supplier B to be displayed.

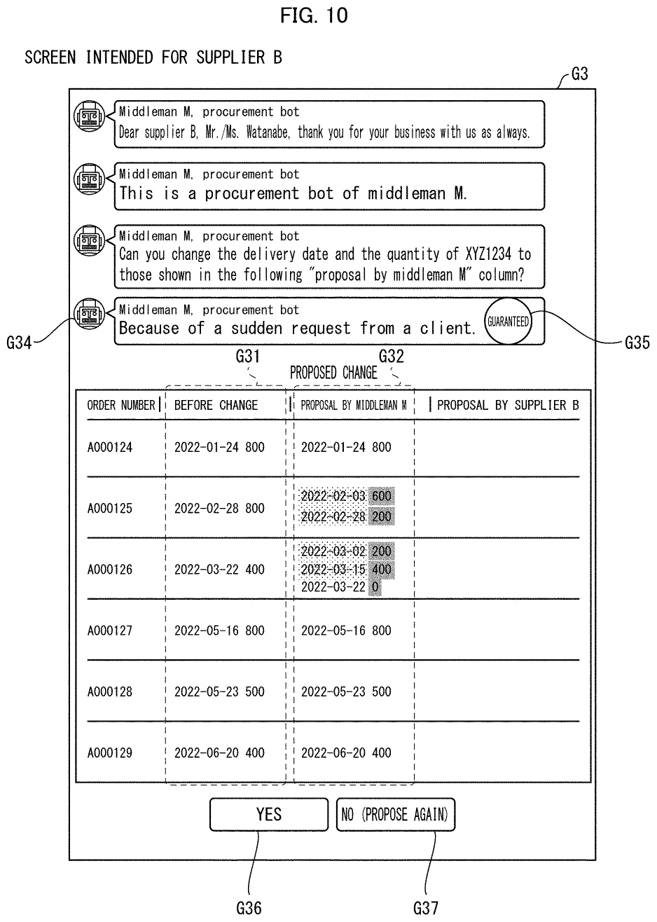

The screen G3 intended for the supplier B is a delivery plan proposal screen. This screen G3 indicates the agreement candidate proposal received from the negotiation apparatus 10. FIG. 10 is a diagram illustrating a detailed example of the screen G3. The screen G3 includes a pre-change delivery plan G31, a middleman's proposal G32 proposed by the negotiation apparatus 10, a reason for provision G34 “because of a sudden request from a client”, and guarantee information G35, as illustrated in FIG. 10. The delivery plans on the respective orders of order numbers A000124 to A000129 before the start of the negotiation B are included in the pre-change delivery plan G31. This pre-change delivery plan G31 has been set in consideration of a stock quantity, a lead time, etc. at the middleman M, according to the pre-change delivery plan G11 for delivering the product to the client A. The middleman's proposal G32 is generated in consideration of a stock quantity, a lead time, etc. in order to meet the client's proposal G23 illustrated in FIG. 9, and the changes from the pre-change delivery plan G31 are the shaded portions.

By recognizing the reason for provision G34, the supplier B is able to increase the feeling that the middleman's proposal G32 which has the changes made thereto is convincing. Further, by recognizing the guarantee information G35, the supplier B is able to confirm the validity of the reason for provision G34, e.g., confirm that the reason for provision G34 is not misinformation. Further, by the supplier B recognizing the reason for provision G34, the possibility that the supplier B agrees to the middleman's proposal G32 increases.

In some cases, even if the supplier B recognizes the reason for provision G34, the supplier B cannot agree to the middleman's proposal G32. Even in such cases, since the supplier B has recognized the reason for provision G34, it is possible to draw a possible compromise from the supplier B. For example, the possibility that the supplier B will generate an agreement candidate proposal to be proposed to a procurement bot next so as to easily obtain an agreement from the procurement bot increases. This results in an increase in the possibility of finally reaching the formation of agreement. Assume here that the supplier B does not agree to the middleman's proposal G32, and an operation object G37 (“no (propose again)” button) is performed on the screen G3. Upon an operation performed on the operation object G37, the screen G3 transitions to the screen G4.

Next, a return to the description of FIG. 7 is made. As illustrated in FIG. 7, the screen G4 intended for the supplier B indicates a delivery plan edit screen. On this screen G4, step PS6 is carried out. In step PS6, the agreement candidate proposal inputting section 23B of the negotiation apparatus 20B accepts an operation of editing a displayed delivery plan, and transmits, to the negotiation apparatus 10, an agreement candidate proposal which includes the delivery plan which has changes made thereto.

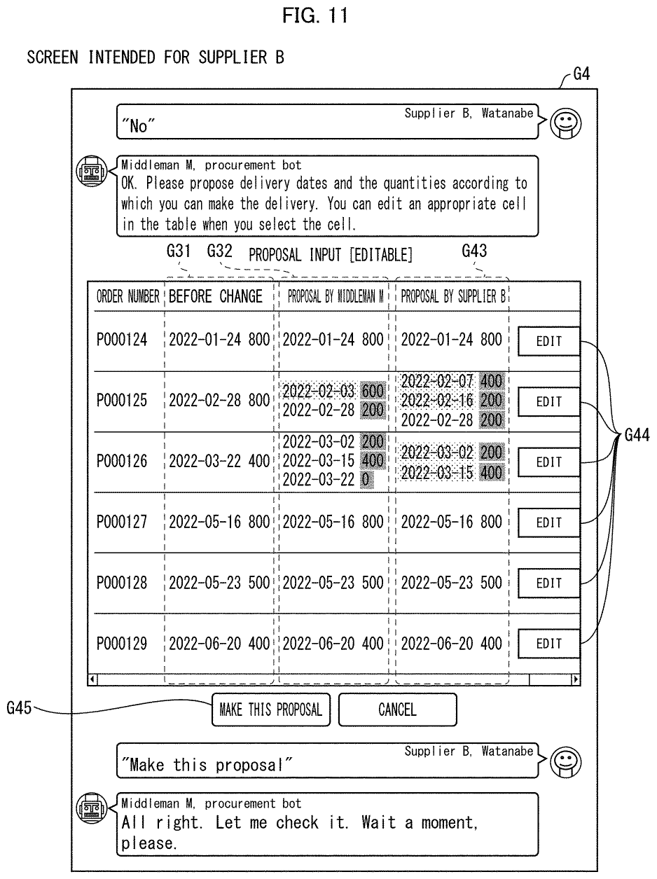

FIG. 11 is a diagram illustrating a detailed example of the screen G4. The screen G4 includes the pre-change delivery plan G31, the middleman's proposal G32, and a supplier's proposal G43 which indicates changes in the delivery plan proposed by the supplier B, as illustrated in FIG. 11. The supplier's proposal G43 includes the middleman's proposal G32 in a pre-edit state, and becomes editable upon the operation performed on an operation object G44 (“edit” button). In this example, shaded portions in the supplier's proposal G43 are changes from the middleman's proposal G42. In the screen G4, upon an operation performed on an operation object G45 (“make this proposal” button), the agreement candidate proposal providing section 22B of the negotiation apparatus 20B transmits, to the negotiation apparatus 10, an agreement candidate proposal which includes the supplier's proposal G43.

Next, a return to the description of FIG. 7 is made. As illustrated in FIG. 7, upon reception of the agreement candidate proposal which includes the supplier's proposal G43, the negotiation apparatus 10 carries out step PS7. Step PS7 includes steps S201 to S206 of the negotiation method S2. That is, the agreement candidate proposal generating section 13 of the negotiation apparatus 10 generates an agreement candidate proposal for sounding the client A out about a change in the delivery plan so as to meet the supplier's proposal G43 which has changes made thereto.

The provision reason adding section 11 of the negotiation apparatus 10 generates a reason for provision with respect to this agreement candidate proposal, and adds the guarantee information. Here, association information that indicates that the negotiation A and the negotiation B are nested inside one another and the negotiation status information (the status where the agreement candidate proposal includes the supplier's proposal G43 which has changes made thereto) for the negotiation B are referred to, and the reason for provision “because of an answer from the supplier that the supplier cannot make the delivery in time” is generated. Further, the agreement candidate proposal providing section 12 of the negotiation apparatus 10 transmits, to negotiation apparatus 20A, the agreement candidate proposal which has added thereto the reason for provision and the guarantee information.

Next, the negotiation apparatus 20A carries out step PS8. The step PS8 includes steps S207 and S208 of the negotiation method S2. That is, the agreement candidate proposal acquiring section 24A of the negotiation apparatus 20A displays the agreement candidate proposal which has added thereto the reason for provision and the guarantee information. This causes the screen G5 intended for the client A to be displayed.

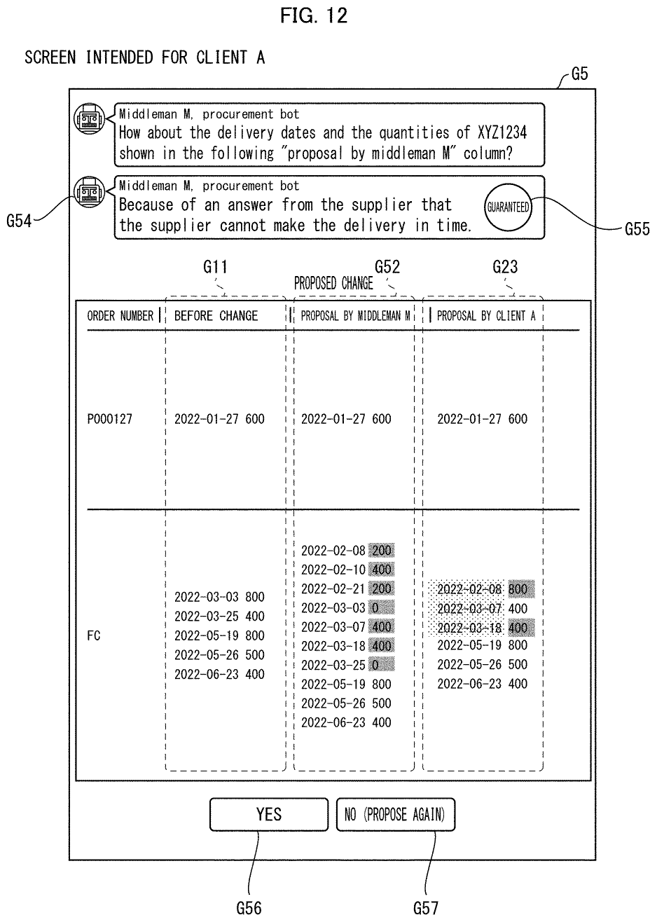

The screen G5 intended for the client A is a delivery plan proposal screen. This screen G5 indicates the agreement candidate proposal received from the negotiation apparatus 10. FIG. 12 is a diagram illustrating a detailed example of the screen G5. The screen G5 includes the pre-change delivery plan G11, a middleman's proposal G52 proposed by the negotiation apparatus 10, the client's proposal G23 proposed by the client A, a reason for provision G54 “because of an answer from the supplier that the supplier cannot make the delivery in time”, and guarantee information G55. The middleman's proposal G52 differs from the client's proposal G23 in the shaded portions. Such a middleman's proposal G52 is generated in consideration of a stock quantity, a lead time, etc. at the middleman M so as to meet the supplier's proposal G43 illustrated in FIG. 11.

By recognizing the reason for provision G54, the client A is able to increase the feeling that the middleman's proposal G52, which differs from the client's proposal G23, is convincing. Further, by recognizing the guarantee information G55, the client A is able to confirm the validity of the reason for provision G54, e.g., confirm that the reason for provision G54 is not misinformation. Further, by the client A recognizing the reason for provision G54, the possibility that the client A agrees to the middleman's proposal G52 increases. In some cases, even if the client A recognizes the reason for provision G54, the client A cannot agree to the middleman's proposal G52. Even in such cases, since the client A has recognized the reason for provision G54, it is possible to draw a possible compromise from the client A. For example, the possibility that the client A will generate an agreement candidate proposal to be proposed to a procurement bot next so as to easily obtain an agreement from the procurement bot. This results in an increase in the possibility of finally reaching the formation of agreement. Assume here that the client A agrees to the middleman's proposal G52, and an operation object G56 (“yes” button) is performed on the screen G5. Upon an operation performed on the operation object G56, the screen G5 transitions to the screen G6.

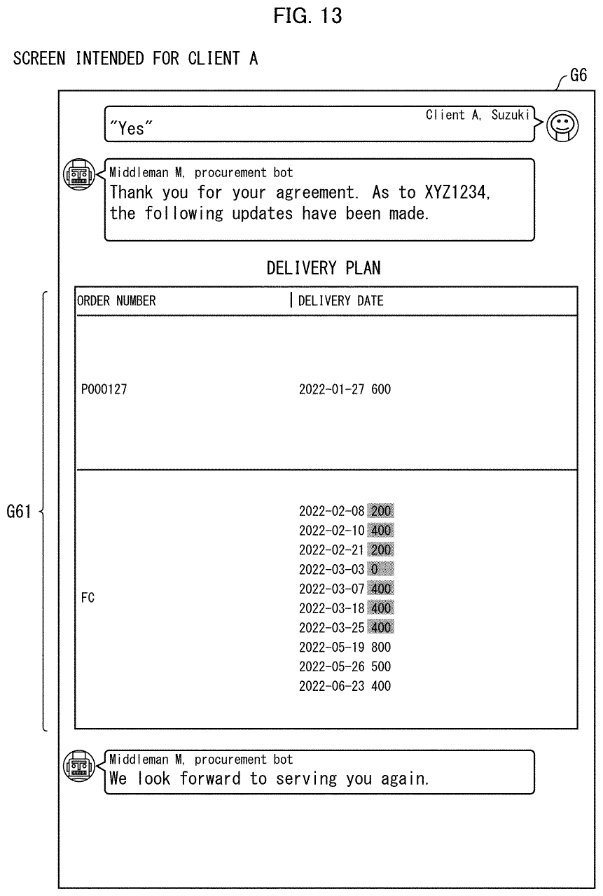

Next, a return to the description of FIG. 7 is made. As illustrated in FIG. 7, the screen G6 intended for the client A indicates a delivery plan agreement screen. The negotiation apparatus 20A carries out step PS9 so that the screen G6 is displayed. In step PS9, the control section 210A of the negotiation apparatus 20A transmits, to the negotiation apparatus 10, an indication of agreement to the agreement candidate proposal which includes the middleman's proposal G52. Further, the control section 210A of the negotiation apparatus 20A displays the screen G6 for indicating an agreement result. FIG. 13 is a diagram illustrating a detailed example of the screen G6 intended for the client A. As illustrated in FIG. 13, the screen G6 includes a delivery plan G61 which is an agreed delivery plan. As the delivery plan G61, the middleman's proposal G52 is applied.

A return to the description of FIG. 7 is made. In step PS10, upon reception of the agreement from the negotiation apparatus 20A, the control section 110 of the negotiation apparatus 10 transmits, to the negotiation apparatus 20B in the negotiation B, an indication of agreement to the agreement candidate proposal which includes the supplier's proposal G43.

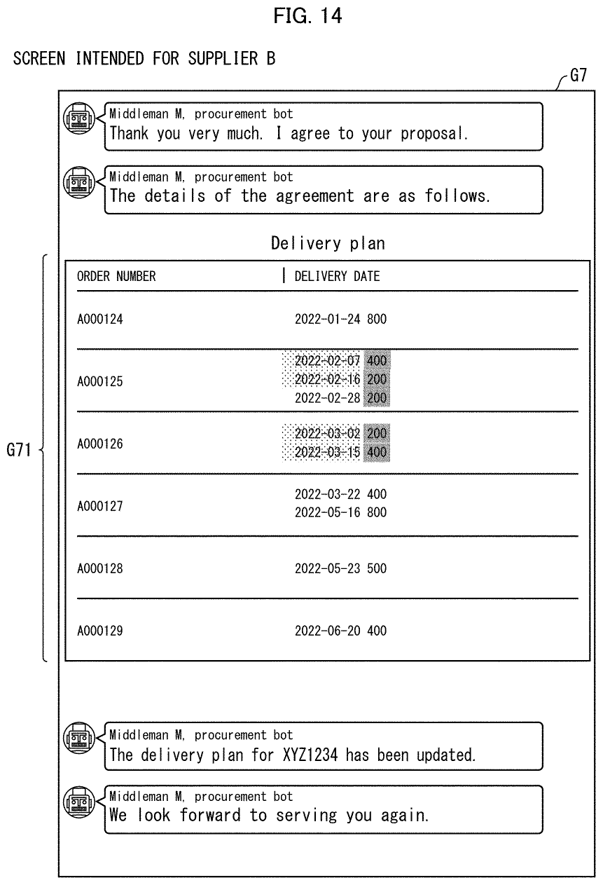

Next, the negotiation apparatus 20B carries out step PS11. In step PS11, upon reception of the agreement to the agreement candidate proposal from the negotiation apparatus 10, the control section 210B of the negotiation apparatus 20B displays the screen G7 for indicating an agreement result. FIG. 14 is a diagram illustrating a detailed example of the screen G7 intended for the supplier B. As illustrated in FIG. 14, the screen G6 includes a delivery plan G71 which is an agreed delivery plan. As the delivery plan G71, the supplier's proposal G43 is applied.

### Flow of Negotiation Method S3

In the present example embodiment, the negotiation apparatus 20A and the negotiation apparatus 20B are usable also in a negotiation X conducted between the negotiation party U-A and the negotiation party U-B, which each are a human being or an organization. In this case, the negotiation apparatus 20A and the negotiation apparatus 20B carry out the following negotiation method S3.

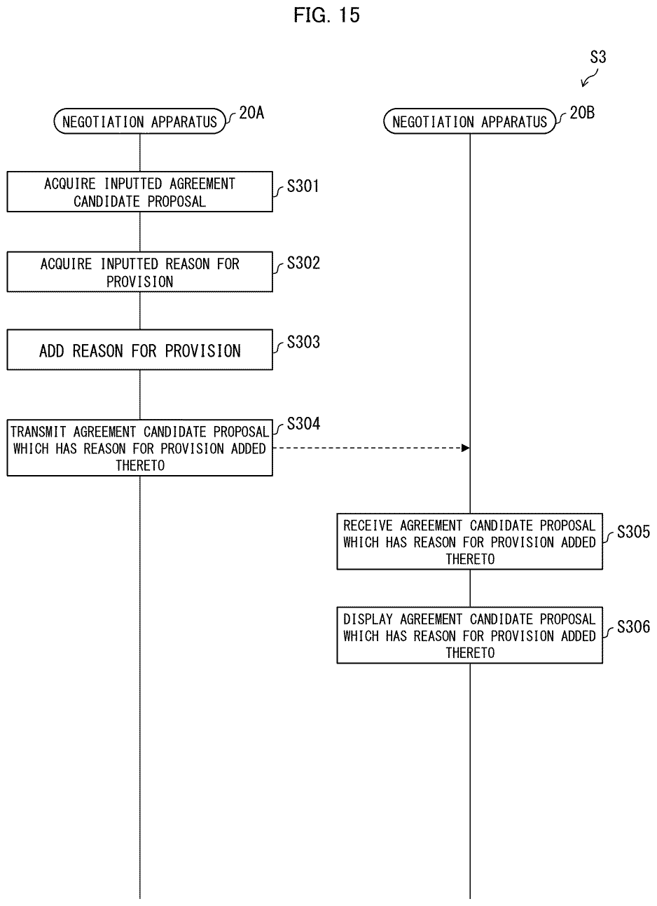

FIG. 15 is a flowchart illustrating the flow of the negotiation method S3. The negotiation method S3 includes a method carried out by the negotiation apparatus 20A as an example of the negotiation apparatus recited in the claims. In this case, the negotiation X is an example of the first negotiation. Further, the negotiation party U-B is an example of the first negotiation party. The negotiation method S3 includes steps S301 to S306, as illustrated in FIG. 7.

In step S301, the agreement candidate proposal inputting section 23A acquires an agreement candidate proposal inputted by the negotiation party U-A via the input equipment 30A. The agreement candidate proposal includes, for example, a delivery plan (including a delivery date and a quantity) desired by the negotiation party U-B at the time of placing an order for a product.

In step S302, the provision reason adding section 21A acquires a reason for provision inputted by the negotiation party U-A via the input equipment 30A. In step S303, the provision reason adding section 21A adds the inputted reason for provision to the agreement candidate proposal. In step S304, the agreement candidate proposal providing section 22A transmits, to the negotiation apparatus 20B, the agreement candidate proposal which has the reason for provision added thereto.

In step S305, the agreement candidate proposal acquiring section 24B receives, from the negotiation apparatus 20A, the agreement candidate proposal which has the reason for provision added thereto. In step S306, the agreement candidate proposal acquiring section 24B displays, on the display equipment 40B, the agreement candidate proposal which has the reason for provision added thereto.

Note that the negotiation method S3 described above and in FIG. 15 is described similarly even in a case of interchanging A and B. In a case of such an interchange, the negotiation apparatus 20B is an example of the negotiation apparatus recited in the claims. Further, the negotiation party U-A is an example of the first negotiation party.

### Specific Example of Negotiation Method S3

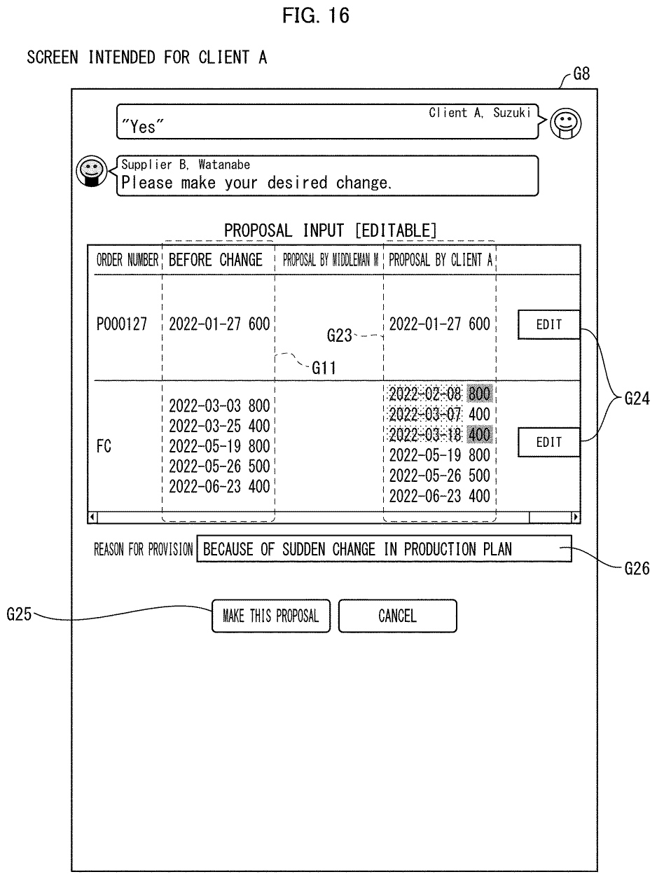

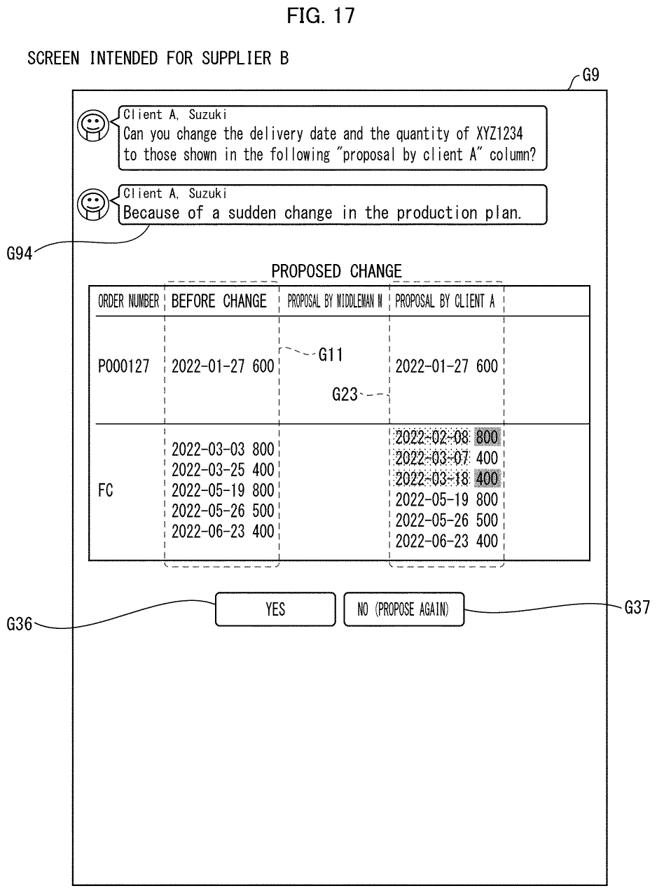

Next, a specific example of the negotiation X conducted with use of the negotiation method S3 is described here with reference to FIGS. 16 and 17. FIG. 16 is a specific example of a screen G8 intended for the client A in the negotiation X. The screen G8 is displayed by the negotiation apparatus 20A. As illustrated in FIG. 16, the screen G8 includes an input object G26 regarding a reason for provision in addition to the same elements G11 and G23 to G25 as in the screen G2 intended for the client A illustrated in FIG. 9. In this example, the provision reason adding section 21A of the negotiation apparatus 20A acquires a reason for provision “because of a sudden change in the production plan” inputted by the client A in the input object G26, and adds the reason for provision to the agreement candidate proposal which includes the client's proposal G23. Further, the agreement candidate proposal providing section 22A of the negotiation apparatus 20A transmits, to the negotiation apparatus 20B, the agreement candidate proposal which has the inputted reason for provision added thereto.

FIG. 17 illustrates a specific example of a screen G9 intended for the supplier B in the negotiation X. The screen G9 is displayed by the negotiation apparatus 20B. The screen G9 includes the pre-change delivery plan G11, the client's proposal G23 proposed by the client A, a reason for provision G94, and operation objects G36 and G37, as illustrated in FIG. 17. The screen G9 differs from the screen G3 intended for the supplier B illustrated in FIG. 10 in that the guarantee information G35 is not included. By recognizing the reason for provision G94 “because of a sudden change in the production plan”, the supplier B is able to increase the feeling that the client's proposal G23 is convincing. Further, it is possible for the supplier B to recognize whether the reasons for provision G34 and G94 are guaranteed, on the basis of whether the guarantee information G35 is added.

### Example Advantages of Present Example Embodiment

With the configuration of the present example embodiment, the reason for provision to be added to an agreement candidate proposal which is to be provided to the negotiation party U-A in a negotiation A is based on the status of another negotiation B, and the negotiation A and the negotiation B thus have an association with each other. Further, the provision reason adding section 11 refers to information which indicates the association between the negotiation A and the negotiation B and information which indicates the status of the other negotiation B to generate a reason for provision, adds the generated reason for provision to the agreement candidate proposal, and then provides the negotiation party U-A with the agreement candidate proposal. With this configuration, it is possible for the negotiation party U-A to recognize the reason for provision regarding the provided agreement candidate proposal and therefore increase the feeling that the agreement candidate proposal is convincing. As a result, the possibility of reaching the formation of agreement on the basis of the agreement candidate proposal is increased. The same example advantage is provided in a case of interchanging A and B.

With the configuration of the present example embodiment, the provision reason adding section 11 further adds guarantee information for guaranteeing the validity of the reason for provision. With this configuration, it is possible for the negotiation party U-A to confirm the validity of the reason for provision added to the agreement candidate proposal and therefore further increase the feeling that the agreement candidate proposal is convincing. The same example advantage is provided in a case of interchanging A and B.

With the configuration of the present example embodiment, the provision reason adding section 21A adds, to an agreement candidate proposal, the reason for provision inputted by the negotiation party U-A via the input equipment 30A and then provides the negotiation party U-B with the agreement candidate proposal. With this configuration, even in a case of a use in conducting a negotiation between the negotiation party U-A and the negotiation party U-B which each are a human being or an organization, it is possible for the negotiation party U-B to recognize the reason for provision regarding the provided agreement candidate proposal and therefore increase the feeling that the agreement candidate proposal is convincing. Furthermore, it is possible for the negotiation party U-B to identify whether the reason for provision is guaranteed, on the basis of whether guarantee information is added to the agreement candidate proposal. The same example advantage is provided in a case of interchanging A and B.

With the configuration of the present example embodiment, the provision reason adding section 11 refers to information which indicates the content of an agreement candidate proposal in the other negotiation B or information which indicates the result of the other negotiation B, as the information which indicates the status of the other negotiation B and which is referred to for generating the reason for provision. With this configuration, it is possible to generate a highly-reliable reason for provision which corresponds with the actual status of an agreement candidate proposal or an agreement result in the other negotiation B. The same example advantage is provided in a case of interchanging A and B.

With the configuration of the present example embodiment, the provision reason adding section 11 refers to information which indicates an association of conducting one of the negotiation A and the negotiation B for the formation of agreement in the other, as the information which indicates the association between the negotiation A and the negotiation B and which is referred to for generating the reason for provision. With this configuration, the status of the formation of agreement in the negotiation B has an influence on the agreement candidate proposal in the negotiation A. Thus, it is possible to generate a highly-reliable reason for provision on the basis of this influence. The same example advantage is provided in a case of interchanging A and B.

### First Variation

In the second example embodiment described above, the association information can be altered so as to indicate not only a nested negotiation but also any of a nested negotiation, a selective negotiation, and a batch negotiation. Note that the association between the negotiation A and the negotiation B is not limited to these associations. In the present variation, examples of these associations are described.

### Selective Negotiation

The selective negotiation is an example of the association of conducting the negotiation A and the negotiation B in parallel for selective formation of agreement only in either the negotiation A or the negotiation B. Examples of the selective negotiation include a competitive quotation negotiation which is conducted before the placement of an order for a product. As a specific example, the negotiation apparatus 10 (negotiation party AI) functions as an agent for an order placer C. The negotiation A is a negotiation in which the order placer C requests a quotation for the product from a vendor candidate A (negotiation party U-A). The negotiation B is a negotiation in which the order placer C requests a quotation for the product from a vendor candidate B (negotiation party U-B). In this case, the negotiation A and the negotiation B are conducted for selectively adopting (forming an agreement to) either one of the quotations.

For example, in a case of adopting the quotation from the vendor candidate B to place an order for the product (the formation of agreement in the negotiation B), it is necessary to cancel the quotation from the vendor candidate A. In this case, the agreement candidate proposal generating section 13 generates an agreement candidate proposal for proposing the cancellation of the quotation in the negotiation A. Further, on the basis of the association information which indicates the selective negotiation and the agreement result (the adoption of quotation) in the negotiation B, the provision reason adding section 11 may generate/add a reason for provision “because of the placement of an order for the product with another vendor candidate” with respect to this agreement candidate proposal.

### Batch Negotiation

The batch negotiation is an example of the association of conducting the negotiation A and the negotiation B in parallel for the formation of agreement both in the negotiation A and the negotiation B. Examples of the batch negotiation include an aggregate negotiation for placing orders for a plurality of parts which constitute a product with respective suppliers B different from each other. As a specific example, the negotiation apparatus 10 (negotiation party AI) functions as an agent for a manufacturer C. The negotiation A is a negotiation in which the manufacturer C places an order with a supplier A (negotiation party U-A) for a part a which forms one part of a product to be manufactured. The negotiation B is a negotiation in which the manufacturer C places an order with a supplier B (negotiation party U-B) for a part b which forms another part of the product. In this case, the negotiation A and the negotiation B are conducted for procuring both (the formation of agreement on both) the part a and the part b which are necessary for the manufacture of the product.

For example, even in a case of provisionally placing an order for the part a (provisional formation of agreement in the negotiation A), if it is impossible to procure the part b (the formation of agreement is not reached in the negotiation B), it is necessary to cancel the provisional order placed in the negotiation A. In this case, the agreement candidate proposal generating section 13 generates an agreement candidate proposal for proposing the cancellation of the provisional placement of the order in the negotiation A. Further, on the basis of the association information which indicates a batch negotiation and the agreement result (the impossibility of procuring the part b) in the negotiation B, the provision reason adding section 11 may generate/add a reason for provision “because of incompleteness of necessary parts” with respect to this agreement candidate proposal.

### Second Variation

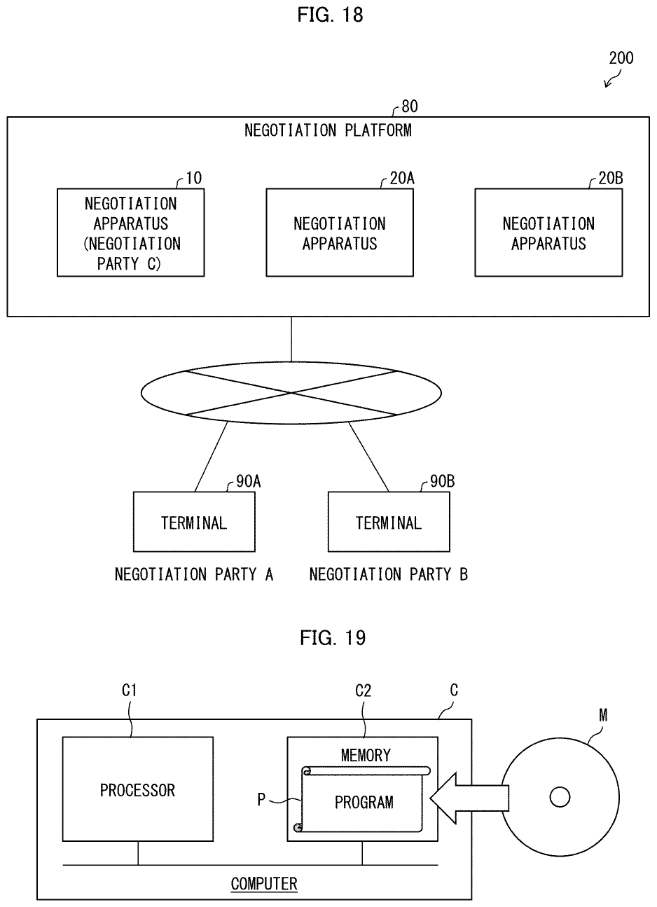

In the second example embodiment described above, the negotiation apparatus 10, the negotiation apparatus 20A, and the negotiation apparatus 20B can be altered so as to be included in a negotiation platform 80 instead of being configured as separate apparatuses which are connected together over a network. FIG. 18 is a block diagram illustrating the configuration of a negotiation system 200 in accordance with a second variation. The negotiation system 200 includes the negotiation platform 80, a terminal 90A, and a terminal 90B, as illustrated in FIG. 18. The negotiation platform 80, the terminal 90A, and the terminal 90B are communicably connected together over a network. The negotiation platform 80 includes the negotiation apparatus 10, the negotiation apparatus 20A, and the negotiation apparatus 20B.

The negotiation platform 80 includes, for example, one or more computers, and a program stored in a memory is executed so that the functions of the negotiation apparatus 10, the negotiation apparatus 20A, and the negotiation apparatus 20B are implemented. The negotiation apparatus 20A functions on the basis of an operation in the terminal 90A used by the negotiation party U-A. Further, the input equipment 30A and the display equipment 40A are connected to or included in the terminal 90A. The negotiation apparatus 20B functions on the basis of an operation performed on the terminal 90B used by the negotiation party U-B. Further, the input equipment 30B and the display equipment 40B are connected to or included in the terminal 90B. Further, the negotiation apparatus 10, the negotiation apparatus 20A, and the negotiation apparatus 20B may provide/acquire an agreement candidate proposal by sharing the agreement candidate proposal via a memory, instead of transmitting and receiving the agreement candidate proposal over the network. The present variation provides the same example advantage as in the second example embodiment described above.

### Third Variation

In the second example embodiment, the negotiation apparatus 20A or the negotiation apparatus 20B may provide the negotiation apparatus 10 with the agreement candidate proposal which has an inputted reason for provision added thereto. In other words, the negotiation apparatus 10 may acquire the agreement candidate proposal which has a reason for provision added thereto, from the negotiation apparatus 20A or the negotiation apparatus 20B. In this case, the negotiation apparatus 10 may carry out a process based on the acquired agreement candidate proposal and reason for provision. For example, the negotiation apparatus 10 may refer to the reason for provision to determine whether to agree to the acquired agreement candidate proposal. This increases the possibility of a determination of agreement, compared with the case of not referring to the reason for provision. As another example, in a case of not agreeing to the agreement candidate proposal, the negotiation apparatus 10 may refer to the reason for provision to generate a new agreement candidate proposal. This makes it possible to generate a new agreement candidate proposal which has a higher possibility of reaching the formation of agreement, compared with the case of not referring to the reason for provision.

### Fourth Variation

The negotiation apparatus 10 in accordance with example embodiments may conduct either one or both of the negotiations A and B with another negotiation apparatus 10. Specifically, the negotiation apparatus 10 may provide the other negotiation apparatus 10 with an agreement candidate proposal which has a reason for provision added thereto. Further, the negotiation apparatus 10 may acquire, from the other negotiation apparatus 10, an agreement candidate proposal which has a reason for provision added thereto. Further, the negotiation apparatus 10 may carry out a process based on the acquired agreement candidate proposal and reason for provision. Specific examples of the process based on the agreement candidate proposal and the reason for provision are as described in the third variation.

### Fifth Variation

In the second example embodiment, the product is not limited to a tangible article but may be an intangible service. In such a case, by the interchange of the “vendor”, “supplier”, etc. described above with, for example, “subcontractor” or the like, the second example embodiment is described similarly.

### Sixth Variation

The negotiation A and the negotiation B are not limited to negotiations related to the placement and acceptance of an order for a product. For example, the negotiation A and the negotiation B may be negotiations related to a schedule coordination. As a specific example, the negotiation apparatus 10 may be a shift coordination bot which coordinates the shifts of employees, the negotiation A may be a negotiation in which an employee A makes a shift-change request, and the negotiation B may be a negotiation in which the shift of an employee B is changed in response to the shift change of the employee A. In this case, the negotiation A and the negotiation B are examples of the nested negotiations one of which is conducted for the formation of agreement in the other.

In this example, the negotiation A may be conducted between the negotiation apparatus 10, which is the shift coordination bot, and the negotiation apparatus 20A used by the employee A, or may be conducted between the negotiation apparatus 10 and another negotiation apparatus 10 which functions as an agent for the employee A. Further, the negotiation B may be conducted between the negotiation apparatus 10, which is the shift coordination bot, and the negotiation apparatus 20B used by the employee B, or may be conducted between the negotiation apparatus 10 and another negotiation apparatus 10 which functions as an agent for the employee B. Further, the negotiation A and the negotiation B may be conducted, by a user X who coordinates the shifts, with use of a negotiation apparatus 20X which is configured in the same manner as the negotiation apparatus 20A, instead of being conducted by the negotiation apparatus 10.

As another specific example of the negotiations related to schedule coordination, the negotiation apparatus 10 may be a conference coordination bot which coordinates a conference schedule, and the negotiation A and the negotiation B may be negotiations for coordinating the schedule conducted respectively with an expected attendee A and an expected attendee B. In this case, the negotiation A and the negotiation B are examples of the batch negotiations which are conducted in parallel for the formation of agreement in both of the negotiations.

In this example, the negotiation A may be conducted between the negotiation apparatus 10, which is the conference coordination bot, and the negotiation apparatus 20A used by the expected attendee A, or may be conducted between the negotiation apparatus 10 and the other negotiation apparatus 10 which functions as an agent for the expected attendee A. Further, the negotiation B may be conducted between the negotiation apparatus 10, which is the conference coordination bot, and the negotiation apparatus 20B used by the expected attendee B, or may be conducted between the negotiation apparatus 10 and the other negotiation apparatus 10 which functions as an agent for the expected attendee B. Further, the negotiation A and the negotiation B may be conducted, by a user X who coordinates a conference schedule, with use of a negotiation apparatus 20X which is configured in the same manner as the negotiation apparatus 20A, instead of being conducted by the negotiation apparatus 10.

For example, the negotiation A and the negotiation B may be negotiations for a transfer of an athlete or the like. As a specific example, the negotiation apparatus 10 may be a transfer negotiation bot for conducting a negotiation for transfer, and the negotiation A and the negotiation B may be negotiations on transfer terms conducted respectively with a transfer destination candidate A and a transfer destination candidate B. In this case, the negotiation A and the negotiation B are examples of the selective negotiations which are conducted in parallel for selective formation of agreement in either one of the negotiations.

In this example, the negotiation A may be conducted between the negotiation apparatus 10, which is the transfer negotiation bot, and the negotiation apparatus 20A used by the transfer destination candidate A, or may be conducted between the negotiation apparatus 10 and the other negotiation apparatus 10 which functions as an agent for the transfer destination candidate A. The negotiation B may be conducted between the negotiation apparatus 10, which is the transfer negotiation bot, and the negotiation apparatus 20B used by the transfer destination candidate B, or may be conducted between the negotiation apparatus 10 and the other negotiation apparatus 10 which functions as an agent for the transfer destination candidate B. Further, the negotiation A and the negotiation B may be conducted, by a user X who conducts the transfer negotiations, with use of a negotiation apparatus 20X which is configured in the same manner as the negotiation apparatus 20A, instead of being conducted by the negotiation apparatus 10.

### Software Implementation Example

Some or all of the functions of each of the negotiation apparatuses 1, 10, 20A, and 20B (hereinafter, referred to as “each apparatus”) may be implemented by hardware such as an integrated circuit (IC chip), or may be implemented by software.

In the latter case, each apparatus is provided by, for example, a computer that executes instructions of a program that is software implementing the functions. An example (hereinafter, computer C) of such a computer is illustrated in FIG. 19. FIG. 19 is a diagram illustrating an example hardware configuration of each apparatus. The computer C includes at least one processor C1 and at least one memory C2. The memory C2 has recorded thereon a program P for causing the computer C to operate as each apparatus. The processor C1 of the computer C retrieves the program P from the memory C2 and executes the program P, so that the functions of each apparatus are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which inputting-outputting equipment such as a keyboard, a mouse, a display, or a printer is connected.

The program P can be recorded on a non-transitory tangible recording medium M capable of being read by the computer C. The recording medium M can be, for example, a tape, a disk, a card, a semiconductor memory, a programmable logic circuit, or the like. The computer C can obtain the program P via such a recording medium M. The program P can be transmitted via a transmission medium. Examples of such a transmission medium can include a communication network and a broadcast wave. The computer C can obtain the program P also via such a transmission medium.

### Additional Remark 1

The present invention is not limited to the above example embodiments, but may be altered in various ways by a skilled person within the scope of the claims. For example, any example embodiment derived by appropriately combining technical means disclosed in the above example embodiments is within the technical scope of the present invention.

### Additional Remark 2

The whole or part of the example embodiments disclosed above can be described as, but not limited to, the following supplementary notes.

### Supplementary Note 1

A negotiation apparatus, including:
a provision reason adding means for adding, in a first negotiation with a first negotiation party, a reason for provision to an agreement candidate proposal which is to be provided to the first negotiation party; and
an agreement candidate proposal providing means for providing the first negotiation party with the agreement candidate proposal which has the reason for provision added thereto.

### Supplementary Note 2

The negotiation apparatus described in supplementary note 1, in which
the reason for provision is a reason for provision based on a status of a second negotiation, which is different from the first negotiation,
the second negotiation is a negotiation with a second negotiation party conducted in association with the first negotiation, the second negotiation party being different from the first negotiation party, and
the provision reason adding means is configured to
   refer to information which indicates an association between the first negotiation and the second negotiation and information which indicates the status of the second negotiation to generate the reason for provision, and add, to the agreement candidate proposal, the reason for provision generated.

### Supplementary Note 3

The negotiation apparatus described in supplementary note 2, in which
the provision reason adding means is configured to further add, to the agreement candidate proposal, guarantee information for guaranteeing validity of the reason for provision.

### Supplementary Note 4

The negotiation apparatus described in any one of supplementary notes 1 to 3, in which
the provision reason adding means is configured to
   add, to the agreement candidate proposal, the reason for provision which is inputted via input equipment.

### Supplementary Note 5

The negotiation apparatus described in any one of supplementary notes 1 to 4, in which
the provision reason adding means is configured to
   refer to content of an agreement candidate proposal in the second negotiation or information which indicates a result of the second negotiation, as the information which indicates the status of the second negotiation.

### Supplementary Note 6

The negotiation apparatus described in supplementary note 2 or 3, in which
the provision reason adding means is configured to
   refer to information which indicates an association of conducting one of the first negotiation and the second negotiation for formation of agreement in the other, as the information which indicates an association.

### Supplementary Note 7

The negotiation apparatus described in supplementary note 2 or 3, in which
the provision reason adding means is configured to
   refer to information which indicates an association of conducting the first negotiation and the second negotiation in parallel for selective formation of agreement only in either the first negotiation or the second negotiation, as the information which indicates an association.

### Supplementary Note 8

The negotiation apparatus described in supplementary note 2 or 3, in which
the provision reason adding means is configured to
   refer to information which indicates an association of conducting the first negotiation and the second negotiation in parallel for formation of agreement in both the first negotiation and the second negotiation, as the information which indicates an association.

### Supplementary Note 9

A negotiation method, including:
a computer adding, in a first negotiation with a first negotiation party, a reason for provision to an agreement candidate proposal which is to be provided to the first negotiation party; and
the computer providing the first negotiation party with the agreement candidate proposal which has the reason for provision added thereto.

### Supplementary Note 10

A program for causing a computer to function as:
a provision reason adding means for adding, in a first negotiation with a first negotiation party, a reason for provision to an agreement candidate proposal which is to be provided to the first negotiation party; and
an agreement candidate proposal providing means for providing the first negotiation party with the agreement candidate proposal which has the reason for provision added thereto.

### Additional Remark 3

The whole or part of the example embodiments disclosed above can further be expressed as follows.

A negotiation apparatus, including at least one processor, the at least one processor carrying out: a provision reason adding process of adding, in a first negotiation with a first negotiation party, a reason for provision to an agreement candidate proposal which is to be provided to the first negotiation party; and a providing process of providing the first negotiation party with the agreement candidate proposal which has the reason for provision added thereto.

This negotiation apparatus may further include a memory, and this memory may have stored therein a program for causing the at least one processor to carry out the provision reason adding process and the providing process. Further, this program may be stored in a computer-readable non-transitory tangible recording medium.

### REFERENCE SIGNS LIST

1, 10, 20, 20A, 20B: Negotiation apparatus
11, 21A, 21B: Provision reason adding section
12, 22A, 22B: Agreement candidate proposal providing section
13: Agreement candidate proposal generating section
14, 24A, 24B: Agreement candidate proposal acquiring section
23: Agreement candidate proposal inputting section
30A, 30B: Input equipment
40A, 40B: Display equipment
80: Negotiation platform
90A, 90B: Terminal
100, 200: Negotiation system
110, 210A, 210B: Control section
120, 220A, 220B: Storage section

What is claimed is:

1. A negotiation apparatus, comprising at least one processor, the at least one processor carrying out:
a provision reason adding process of adding, in a first negotiation with a first negotiation party, a reason for provision to an agreement candidate proposal which is to be provided to the first negotiation party; and
an agreement candidate proposal providing process of providing the first negotiation party with the agreement candidate proposal which has the reason for provision added thereto.

2. The negotiation apparatus according to claim 1, wherein
the reason for provision is a reason for provision based on a status of a second negotiation, which is different from the first negotiation,
the second negotiation is a negotiation with a second negotiation party conducted in association with the first negotiation, the second negotiation party being different from the first negotiation party, and
in the provision reason adding process, the at least one processor
refers to information which indicates an association between the first negotiation and the second negotiation and information which indicates the status of the second negotiation to generate the reason for provision, and add, to the agreement candidate proposal, the reason for provision generated.

3. The negotiation apparatus according to claim 2, wherein
in the provision reason adding process, the at least one processor adds, to the agreement candidate proposal, guarantee information for guaranteeing validity of the reason for provision.

4. The negotiation apparatus according to claim 1, wherein
in the provision reason adding process, the at least one processor
adds, to the agreement candidate proposal, the reason for provision which is inputted via input equipment.

5. The negotiation apparatus according to claim 2, wherein
in the provision reason adding process, the at least one processor
refers to content of an agreement candidate proposal in the second negotiation or information which indicates a result of the second negotiation, as the information which indicates the status of the second negotiation.

6. The negotiation apparatus according to claim 2, wherein
in the provision reason adding process, the at least one processor
refers to information which indicates an association of conducting one of the first negotiation and the second negotiation for formation of agreement in the other, as the information which indicates an association.

7. The negotiation apparatus according to claim 2, wherein
in the provision reason adding process, the at least one processor
refers to information which indicates an association of conducting the first negotiation and the second negotiation in parallel for selective formation of agreement only in either the first negotiation or the second negotiation, as the information which indicates an association.

8. The negotiation apparatus according to claim 2, wherein
in the provision reason adding process, the at least one processor
refers to information which indicates an association of conducting the first negotiation and the second negotiation in parallel for formation of agreement in both the first negotiation and the second negotiation, as the information which indicates an association.

9. A negotiation method, comprising:
a computer adding, in a first negotiation with a first negotiation party, a reason for provision to an agreement candidate proposal which is to be provided to the first negotiation party; and
the computer providing the first negotiation party with the agreement candidate proposal which has the reason for provision added thereto.

10. A non-transitory recording medium having recorded thereon a program for causing a computer to carry out:
a provision reason adding process of adding, in a first negotiation with a first negotiation party, a reason for provision to an agreement candidate proposal which is to be provided to the first negotiation party; and
an agreement candidate proposal providing process of providing the first negotiation party with the agreement candidate proposal which has the reason for provision added thereto.
